(19) United States
(12) Patent Application Publication
(10) Pub. No.: US 2002/0097390 A1
(43) Pub. Date: Jul. 25, 2002

(54) Closed-loop infrared countermeasure system using a high frame rate infrared receiver with nulling sequence

(75) Inventors: Allen T. Hicks, Uniontown, OH (US); Timothy E. MacKlin, Newton Falls, OH (US); Dennis L. Carter, Hudson, OH (US); Susan E. Hall, Wadsworth, OH (US)

Correspondence Address: Ray L. Weber, Renner, Kenner, Greive, Bobak, Taylor & Weber, Fourth Floor, First National Tower, Akron, OH, 44308-1456, US

(73) Assignee: LOCKHEED MARTIN TACTICAL DEFENSE SYSTEMS,INC

(21) Appl. No.: 10/093,975

(22) Filed: Mar. 8, 2002

Related U.S. Application Data
(63) Continuation-in-part of application No. 09/072,841, filed on May 5, 1998, now Pat. No. 6,369,885.

(51) Int. Cl. G01C 1/00; G01B 11/26

(52) U.S. Cl. 356/139.04

(57) ABSTRACT

A missile tracking and deflection system for protecting a platform includes a missile warning system for detecting the presence of a missile and generating a warning signal. A countermeasure processor receives the warning signal and analyzes characteristics of the missile to prioritize a trajectory signal. A track processor receives the trajectory signal and generates a pointer signal. The system also includes a receiver, which is positioned by a pointer that receives the pointer signal, for receiving a passive and/or active signature of the missile to confirm the presence thereof. The countermeasure processor then directs a laser beam at the missile to determine its operational parameters and receives an active signature from the missile. The receiver delivers the passive and/or active signatures to the countermeasure processor and the track processor, wherein the track processor updates the pointer signal and the countermeasure processor generates a jam code delivered by the laser beam to divert the trajectory of the missile away from the platform. A nulling or blanking signal may be used during generation of the laser beam to improve reception of the active signature.

### CROSS REFERENCE TO RELATED APPLICATION

This is a continuation-in-part of copending patent application Ser. No. 09/072,841, filed May 5, 1998, entitled “Closed-Loop Infrared Countermeasure Systems Using High Frame Rate Infrared Receiver.”

### TECHNICAL FIELD

The present invention herein resides in the art of defense systems for diverting the trajectory of incoming missiles. More particularly, the present invention relates to a system which provides simultaneous tracking and identification/classification functions with an infrared receiver having a focal plane array. Specifically, the present invention relates to a system which generates a laser beam to illuminate the missile and which provides variable imaging rates to detect, jam and divert an incoming infrared missile, wherein the system is enhanced by nulling the infrared receiver during generation of the laser beam.

### BACKGROUND ART

To protect and defend military platforms, such as ships, aircraft, and ground-based installations, it is known to provide countermeasure systems that detect incoming threats such as enemy aircraft or missiles. Known systems detect incoming threats, such as infrared missiles, and then deploy defensive countermeasures in an attempt to destroy or divert the threat. These systems are referred to as open-loop systems since no immediate determination as to the type of threat or effectiveness of the countermeasure is readily available. Due to the inefficiency of the open-loop systems, closed-loop systems have been developed.

There are known performance benefits to using a directional, laser-based, closed-loop infrared countermeasure system to defeat infrared missiles. In a closed-loop system, the incoming missile is identified and the countermeasure system generates or tunes a jam code according to the specific incoming missile. The optimized jam code is directed at the missile which executes a maximum turn-away from its intended target. An additional feature of closed-loop techniques is the ability to monitor the classification and identification process during the jamming sequence. This provides a direct observation of the countermeasure effectiveness as well as an indication of the necessary corrective action required for the jam code. It will be appreciated that the benefits of the closed-loop performance system must be balanced against the cost of upgrading existing infrared directional countermeasure systems with a closed-loop capability, or against the cost of developing an entirely new closed-loop system.

One possible configuration for introducing a closed-loop receiver into a directional countermeasure system is to use a high resolution tracking sensor side-by-side with an infrared detector assembly. Accordingly, an independent receive channel, which is a separate optical path, must be added to the detection system with a separate expensive cooled detector. The cost and size impact of such a configuration to the countermeasure system is prohibitive.

Another approach is to incorporate an infrared detector assembly into the countermeasure system and split a portion of the received optical path for the high resolution tracking sensor. Unfortunately, this approach causes at least a 50% receive loss for both the track sensor and the receiver, plus the cost for adding another cryogenically cooled detector. Another problem with this approach is that the apertures of the sensor and the receiver may not match which would require a larger overall assembly to accommodate both.

Based upon the foregoing, it is apparent that there is a need in the art for a single imaging infrared receiver having a focal plane array capable of sufficient frame rates to provide sensor data for three primary closed-loop countermeasure functions. The receiver must have a passive high resolution tracking capability, it must be able to receive and process laser signals, and finally, the receiver must be able to perform countermeasure effectiveness measurements. Further, there is a need for the receiver to be nulled for a predetermine period of time so as to avoid interference from the laser signals.

### DISCLOSURE OF INVENTION

In light of the foregoing, it is a first aspect of the present invention to provide a closed-loop infrared countermeasure system using a high frame rate infrared receiver with nulling sequence.

The foregoing and other aspects of the present invention, which shall become apparent as the detailed description proceeds, are achieved by a missile tracking and deflecting system, comprising: a countermeasure processor for generating a trajectory signal of a detected missile; a track processor for receiving the trajectory signal and generating a pointer trajectory signal; a pointer for receiving the pointer trajectory signal to position the pointer toward the missile; a laser positioned by the pointer; and an infrared receiver comprising an infrared focal plane array that integrally and simultaneously combines a tracking camera and a laser receiver, the infrared receiver positioned by the pointer; the countermeasure processor simultaneously generating an initiation signal and a blanking signal, the initiation signal causing the laser to generate a laser pulse within a predetermined interval; the blanking signal causing the infrared receiver to turn off during the laser pulse for a time slightly longer than the laser pulse.

Still other aspects of the present invention are achieved by a method for diverting the trajectory of a missile, comprising; analyzing characteristics of a detected missile with a countermeasure processor which generates a trajectory signal; processing the trajectory signal to generate a trajectory pointer signal; receiving the pointer signal in a pointer that follows the missile trajectory, the pointer positioning a laser and an infrared receiver which has a single focal plane array that integrally and simultaneously combines the functions of a tracking camera and a laser receiver; simultaneously generating an initiation signal and a blanking signal from the countermeasure processor; generating a laser pulse from the laser upon receipt of the initiation signal with a predetermined interval; receiving the blanking signal in the infrared receiver; turning the infrared receiver off upon receipt of the blanking signal during the laser pulse for a time slightly longer than the laser pulse.

### BRIEF DESCRIPTION OF THE DRAWINGS

For a complete understanding of the objects, techniques, and structure of the invention, reference should be made to the following detailed description and accompanying drawings, wherein:

FIG. 1 is a schematic representation of a platform and an incoming missile threat;

FIG. 2 is a schematic diagram of a closed-loop infrared countermeasure system according to the present invention;

FIG. 3 is a schematic representation of an infrared receiver tracking and delivering a jam code to an incoming missile;

FIG. 4 is a flow chart showing operation of the infrared countermeasure system; and

FIG. 5 is a timing sequence showing generation of a laser beam and integration of the return signatures.

### BEST MODE FOR CARRYING OUT THE INVENTION

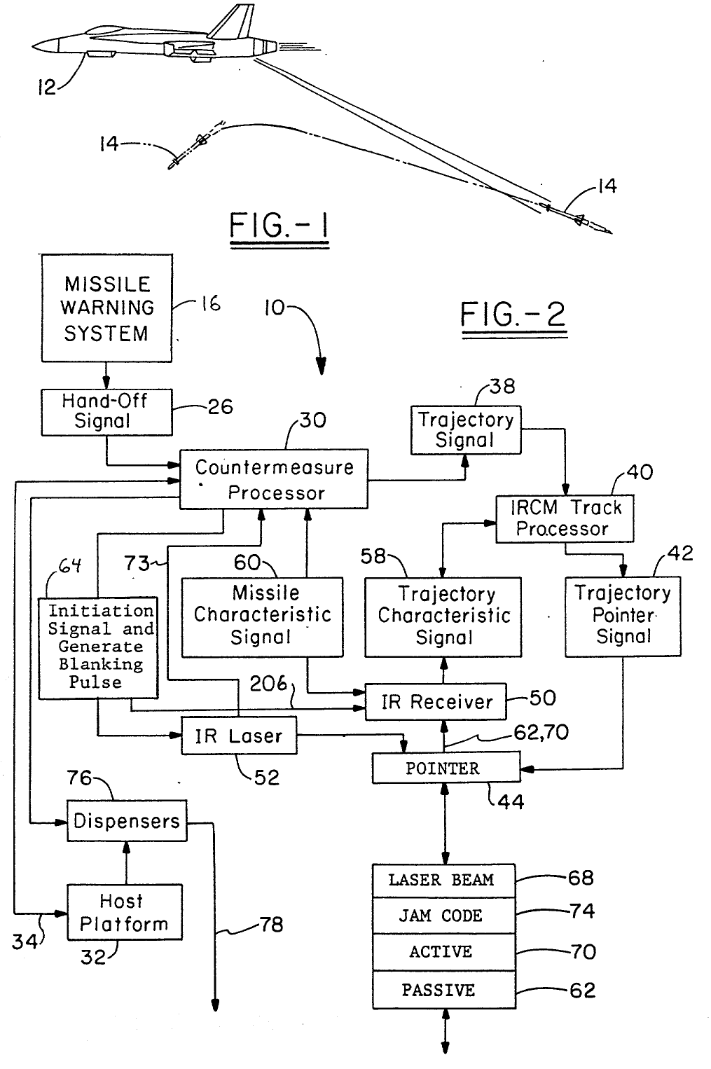

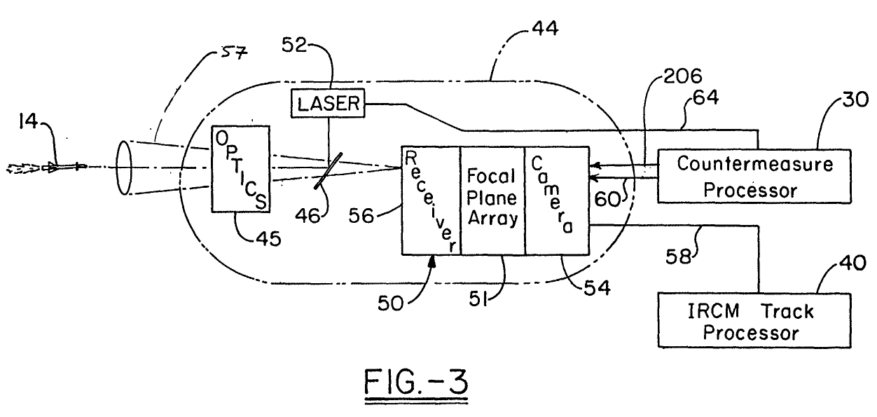

Referring now to the drawings, and in particular, to FIGS. 1 and 2, it can be seen that a closed-loop infrared countermeasure system, according to the present invention, is designated generally by the numeral 10. It will be appreciated that the system 10 is incorporated into a platform 12 such as a plane, ship, or ground-based installation. The system 10 is employed to detect the presence of an in-bound infrared missile 14, determine the operating characteristics of the missile, and then divert the trajectory of the missile so that it turns away from the platform 12. The system 10 may also be employed to track any moving object by observing any time varying frequency components thereof. Although an infrared-based system is disclosed, it will be appreciated that the aspects of the present invention are applicable to other frequency-observable phenomena.

As seen in FIG. 2, the system 10 includes a missile warning system 16 which may be carried by the platform 12. The missile warning system 16 detects the presence of an object, which could be an incoming threat, by either an infrared camera, an ultraviolet camera, by sight, by radar, or any other device which can generate information about the possible location and trajectory of the object. The missile warning system 16 acquires passive information about the object and determines if the object is in fact a missile. Accordingly, the missile warning system 16 generates a hand-off signal 26 which is received by the system 10. It will be appreciated that the missile warning system 16 is a low resolution system that looks at high spatial coverage areas for the primary purpose of detecting the presence of any type of threat, such as a missile or enemy aircraft. The hand-off signal 26 includes information such as amplitude, how long the threat has been tracked, speed, intensity, and angle from the platform 12.

A countermeasure processor 30, which provides the necessary software, hardware, and memory for controlling and coordinating the various aspects of the system 10, receives the hand-off signal 26. The countermeasure processor 30 prioritizes the threat according to the information acquired and predetermined criteria. The countermeasure processor 30 is in communication with a host platform 32 via host signal 34 for the purpose of communicating with the command structure controlling operation of the platform 12. Initially, the countermeasure processor 30 generates a trajectory signal 38 received by an infrared countermeasure track processor 40. Accordingly, the track processor 40 initiates a tracking sequence for the potential in-bound missile 14 indicated by the hand-off signal 26. In particular, the track processor 40 generates a trajectory pointer signal 42 which provides mechanical control functions to position selected components of the system 10 in the appropriate direction.

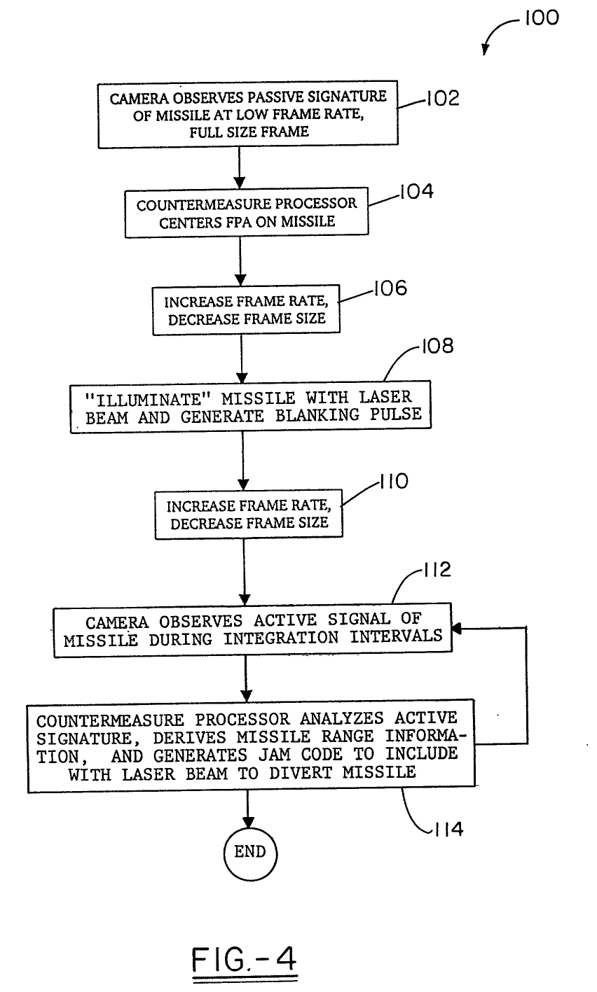

A pointer 44, as seen in FIGS. 2 and 3, receives the pointer signal 42 and slews the components thereof to observe the angle and position of the in-bound missile 14. The pointer 44 includes pointer optics 45 which are used to facilitate the sending and receiving of optical transmissions. The pointer 44 carries an infrared receiver 50 and an infrared laser 52 which are bore sighted. This is accomplished by positioning a mirror 46 between the infrared receiver 50 and the pointer optics 45, and between the laser 52 and the pointer optics 45. The mirror 46 is able to reflect the laser beam, through the optics 45, while allowing transmission of reflected signals to the infrared receiver 50.

The infrared receiver 50 is a high frame rate, infrared focal plane array 51 which integrally and simultaneously combines the functions of a high resolution track sensor or a camera 54 and a laser receiver 56. In the preferred embodiment, the receiver 50 has an aperture of about 35-50 mm, although other aperture sizes could be used. The pointer 44 provides an optical path 57 for the infrared receiver 50. The infrared receiver 50 generates a trajectory characteristic signal 58 that is received by the track processor 40 for updating the trajectory pointer signal 42.

The infrared receiver 50 provides a single focal plane array generally designated by the numeral 51 as best seen in FIG. 3 to function both as a passive viewing device and an active viewing device. The receiver 50 has a relatively large field of view, wherein the focal plane array 51 provides a full frame, 512×512 pixel display that generates an optical image that is converted into an electrical signal. Of course, other size focal plane arrays may be used. The receiver 50 functions as the tracking camera 54 by employing the focal plane array 51 to passively observe the trajectory of the missile. Since the receiver 50 employs a single focal plane array, the function of the camera 54 is inherently bore-sighted with the function of the laser receiver 56. Accordingly, both the receiver 56 and the camera 54 functionally observe substantially the same scene. As will be discussed hereinbelow, the laser receiver 56 functions to employ relatively smaller portions of the focal plane array to actively observe the trajectory of the missile. The infrared receiver 50 communicates with the countermeasure processor 30 via a missile characteristic signal 60.

Referring now to FIG. 4, an operational flow of the countermeasure processor system is designated generally by the numeral 100. After the pointer 44 slews itself toward the missile 14, the tracking camera 54, at step 102, observes a passive signature 62, typically thermal emissions generated by the missile. Other possible passive signatures that may be viewed with a similar camera are light frequencies in the visible or near visible spectrum including ultraviolet light, or acoustic signals. At step 102, a relatively low frame rate , up to about 120 frames per second and preferably about 60 frames per second, is used by the track camera 54 to communicate information obtained from the passive signature 62 to the track processor 40 via the trajectory characteristic signal line 58. Accordingly, at step 104, the countermeasure processor 30 instructs the track processor 40 to position the pointer 44 so that the missile 14 is centered in the focal plane array 51 of the receiver 50. At step 106, the countermeasure processor 30 instructs the track processor 40 to increase the imaging rate to a frame rate of the focal plane array of the receiver 50 to between about 120 to about 1000 frames per second and preferably about 400 frames per second. When this is done, the observation area of the focal plane array is reduced to a mid-size frame smaller than full frame or preferably to about 32×32 pixels centered about the missile 14 as it appears on the focal plane array 51.

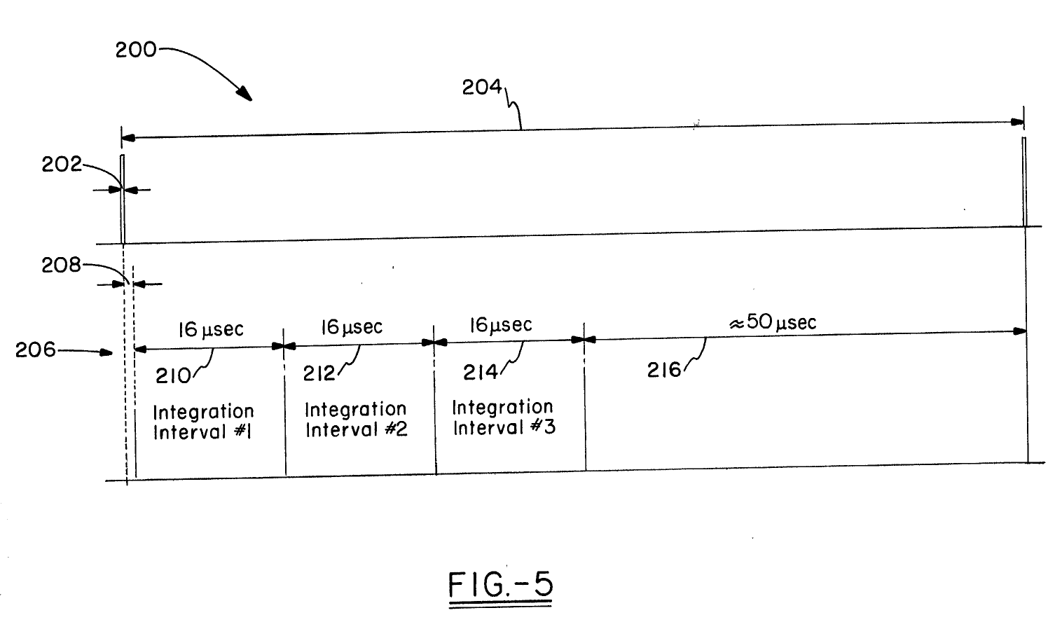

At step 108, the countermeasure processor 30 generates an initiation signal 64 which instructs the infrared laser 52 to “illuminate” the missile 14. Upon receipt of the initiation signal 64, a laser beam 68 is generated by the laser 52 and directed at the missile 14 through the optics 45. As seen in FIG. 5, the laser beam 68 is a periodic pulsed signal 200 that includes a laser pulse width 202 which is about less than 20 nanoseconds long and within a laser pulse interval 204 that is about 100 microseconds long. Accordingly, after completion of each interval 204 another pulse width 202 is generated. In any event, as the laser beam 68 impinges upon the missile 14, an active signature 70 is reflected back through the optics 45 and received by the laser receiver 56 aspect of the receiver 50. Simultaneous with the generation of the initiation signal 64, the countermeasure processor 30 generates a blanking signal 206 that is sent to and received by the infrared receiver 50.

The blanking signal 206 instructs the focal plane array 51 to initiate a hold-off time 208 prior to the beginning of a first integration interval 210. The hold-off time 208 during the blanking signal 206 is generally longer than the laser pulse width 202 generated by the laser beam 68 to allow for back scatter decay. The blanking signal 206 essentially turns the infrared receiver 50 off for a short period of time and permits the laser beam signal and the signatures 62 and 70 to share the same optical path if it is desired in the system implementation without detrimental affects from the laser back scatter detected by the receiver. In particular, the hold-off time 208 is about 0.5 to 1.0 microseconds long to allow for generation of the laser pulse width 202 plus additional time to allow for light from the laser to diffuse prior to the turning the receiver 50 on.

During the entire laser pulse interval 204, the blanking signal 200 may be followed by two or more integration intervals 210, 212, 214, in which the focal plane array captures the active signature from the missile 14.

The countermeasure processor 30 then instructs the track processor 40 to increase the imaging rate of the receiver 50, at step 110, to employ a frame rate of up to 50,000 frames per second and preferably about 32,000 frames per second over an even smaller sub-array frame size of about 16×16 pixels. In other words, the ultra-fast imaging rate may be applied to a pixel array of 1×1 up to an array size employed for the prior imaging rate. It will be appreciated that these imaging rates are only limited by the operational characteristics of the receiver 50. The image of the active signature 70 is processed at step 112, in the manner described above to maintain the high resolution track on the missile 14. The results are read out of the focal plane array during a readout signal interval 216, which is about 50 microseconds long, and sent to the countermeasure processor 30 which derives range information by determining which integration interval 210, 212, or 214, contains the active signature 70. It will be appreciated by those skilled in the art that the range ambiguity will be a function of the time duration of the integration intervals. In other words, shorter intervals provide less ambiguity, inasmuch as the range information can be further pin-pointed to a particular time period. Multiple integration intervals 210, 212, 214 also allow the use of peak laser power detection and range-gating, which significantly reduces external thermal noise and increases the magnitude of the active signature 70 relative to the thermal noise. A variation on multiple integration times may occur when the integration intervals 210, 212, and 214 are of unequal duration and/or are continuously variable. Both multiple integration intervals and variable intervals provide identical functions as described above. Those skilled in the art will appreciate that the laser receiver 56 employs pixel detectors, such as photo diodes, which are digitally sampled and processed by the countermeasure processor 30 via the optical path 57 and the missile characteristic signal 60. The processor 30 in turn performs a Fourier analysis of the amplitude modulation or time varying characteristics of the incoming signals 62, 70 via the optical path 57 and/or the signal 60 to determine operational characteristics of the missile 14. The processor 30 monitors the performance of the laser 52 via a signal line 73.

Once the active signature 70 is returned from the missile 14, the infrared receiver 50 simultaneously generates corresponding updated signals for the trajectory characteristic signal 58, which in turn updates the pointer trajectory signal 42, and the missile characteristic signal line 60. At this time, the countermeasure processor 30 analyzes the components of the active signature 70 and generates a jam code 74, at step 114, for inclusion with the laser beam 68. Accordingly, the missile 14 is diverted from the actual platform and eventually self-destructs, as the jam code 74 is included with the laser beam 68. A countermeasure effectiveness measurement is performed by the countermeasure processor 30 by simultaneously examining dynamic track and classification and identification information provided by the trajectory characteristic signal 58 and the signature 70. As such, if the jam code 74 is found to be ineffective, the countermeasure processor 30 can immediately make adjustments thereto.

Based upon the foregoing structure and method of the use presented above, the system 10 effectively analyzes a trajectory of an incoming missile and its operational characteristics and generates a jam code to divert the trajectory of the missile away from the platform. Previous approaches to closed-loop laser infrared countermeasure required the use of a separate laser receiver to collect interrogation signals from an infrared missile and a separate infrared focal plane array camera for high resolution tracking of the threat. The separate laser interrogation receiver has significant negative system impacts on the cost, size, weight, power efficiency, performance, reliability, and maintainability. By employing the present invention, wherein the laser receiver function and the high resolution tracking function are incorporated into a single, infrared focal plane array, these system impacts are eliminated or greatly reduced. Still yet another advantage of the present invention is that current open-loop systems may be converted to closed-loop systems with substantially improved performance in defending from missile attacks. Moreover, the present invention avoids adding additional operating equipment which would require the splitting of signals and reducing the strength thereof to the detriment of the host platform 32. Another advantage of the present invention is that the same signal may be processed with a relatively smaller aperture than may be otherwise provided. Yet a further advantage of the present invention is that the use of the blanking pulse reduces the interference generated by the laser beam. This permits enhanced detection of the active signature signal generated by the reflection of an incoming threat that is subjected to the laser beam. This improves the receiver response and also allows for the determination of range information that is vital in the closed-loop analysis of the threat.

Thus, it can be seen that the objects of the invention have been satisfied by the structure and use of the invention as presented above. While in accordance with the patent statutes, only the best mode and preferred embodiment of the invention has been presented and described in detail, it is to be understood that the invention is not limited thereto or thereby. Accordingly, for an appreciation of the true scope and breadth of the invention, reference should be made to the following claims.

What is claimed is:

1. A missile tracking and deflecting system, comprising:
a countermeasure processor for generating a trajectory signal of a detected missile;
a track processor for receiving said trajectory signal and generating a pointer trajectory signal;
a pointer for receiving said pointer trajectory signal to position said pointer toward the missile;
a laser positioned by said pointer; and
an infrared receiver comprising an infrared focal plane array that integrally and simultaneously combines a tracking camera and a laser receiver, said infrared receiver positioned by said pointer;
said countermeasure processor simultaneously generating an initiation signal and a blanking signal, said initiation signal causing said laser to generate a laser pulse within a predetermined interval;
said blanking signal causing said infrared receiver to turn off during said laser pulse for a time slightly longer than said laser pulse.

2. The system according to claim 1, wherein said laser pulse is reflected by the missile to generate an active signature, and wherein said infrared receiver, after termination of said blanking pulse, generates at least two integration intervals for the purpose of capturing said active signature to determine range information of the missile.

3. The system according to claim 2, wherein said at least two integration intervals are of variable duration.

4. The system according to claim 2, wherein said infrared receiver remains on after said at least two integration intervals terminate for a read-out signal interval which ends at about the same time as predetermined interval.

5. A method for diverting the trajectory of a missile, comprising;
analyzing characteristics of a detected missile with a countermeasure processor which generates a trajectory signal;
processing said trajectory signal to generate a trajectory pointer signal;
receiving said pointer signal in a pointer that follows the missile trajectory, said pointer positioning a laser and an infrared receiver which has a single focal plane array that integrally and simultaneously combines the functions of a tracking camera and a laser receiver;
simultaneously generating an initiation signal and a blanking signal from said countermeasure processor;
generating a laser pulse from said laser upon receipt of said initiation signal with a predetermined interval;
receiving said blanking signal in said infrared receiver;
turning said infrared receiver off upon receipt of said blanking signal during said laser pulse for a time slightly longer than said laser pulse.

6. The method according to claim 5, further comprising:
turning said infrared receiver on after completion of said blanking signal; and
observing an active signature by said laser receiver that is a reflection of said laser pulse by the missile.

7. The method according to claim 6, further comprising:
employing at least two integration intervals by said laser receiver to observe said active signature for the purpose of determining range information.

8. The method according to claim 7, further comprising;
varying said integration intervals.

9. The method according to claim 7, further comprising:
leaving said laser receiver on after completion of said employing step until completion of said predetermined interval.
